(19) United States
(12) Patent Application Publication
(10) Pub. No.: US 2019/0148926 A1
(43) Pub. Date: May 16, 2019

(54) Below Surface Electrical Connection Box System and Method of Use

(71) Applicant: Jerry Dean Travis, Westfield, IN (US)

(72) Inventor: Jerry Dean Travis, Westfield, IN (US)

(21) Appl. No.: 16/129,745

(22) Filed: Sep. 12, 2018

Related U.S. Application Data
(60) Provisional application No. 62/585,799, filed on Nov. 14, 2017.

(51) Int. Cl. H02G 3/18

(52) U.S. Cl. CPC H02G 3/185

(57) ABSTRACT

Provided is a below surface electrical connection box system and method of use.

### CROSS-REFERENCE TO RELATED APPLICATIONS

Cross-reference to related applications is to previously submitted provisional patent application number 62585799 dated 14 Nov. 2017 for invention of the same name and by the same inventor.

### FEDERALLY SPONSORED RESEARCH OR DEVELOPMENT

None.

### TECHNICAL FIELD

The present invention relates generally to the field of electric outlets for cord plugs, and more specifically to a weather-proof outlet for outdoor and indoor uses, including an outlet housing for mounting in the ground or in a floor, and methods of using same.

### BACKGROUND

The following United States patent(s) and published United States patent application(s) are incorporated herein by reference in their entireties, as if reproduced in full herein:

Diening, et al., U.S. Pub. No. 20100096157 A1, published on Apr. 22, 2010;

Siems, U.S. Pat. No. 5,342,993 A, issued on Aug. 30, 1994;

Bartee, U.S. Pat. No. 5,023,396 A, issued on Jun. 11, 1991;

Brownlie, U.S. Pat. No. 4,984,982 A, issued on Jan. 15, 1991;

Brownlie, U.S. Pat. No. 5,122,069 A, issued on Jun. 16, 1992;

Jonsson, U.S. Pat. No. 4,355,197 A, issued on Oct. 19, 1982;

Dunn, U.S. Pat. No. 3,992,070 A, issued on Nov. 16, 1976;

Press, U.S. Pat. No. 3,622,684 A. issued on Nov. 23, 1971; and

MacLeod, U.S. Pat. No. 3,131,512 A, issued on May 5, 1964.

### SUMMARY

The present invention elegantly overcomes various drawbacks and limitations of past systems and provides numerous additional benefits as will be apparent to persons of skill in the art. The invention is shown and described in this non-provisional patent application in the accompanying written description and figures, which include drawings showing particular aspects of certain example embodiments. Additional aspects, alternatives and variations as would be apparent to persons of skill in the art are also disclosed herein and are specifically contemplated as included as part of the invention. The invention is set forth only in the claims as allowed by the patent office in this or related applications, and the following summary descriptions of certain examples are not in any way to limit, define or otherwise establish the scope of legal protection.

### BRIEF DESCRIPTION OF THE DRAWINGS

The accompanying figures and drawings illustrate certain aspects of example embodiments of the invention.

FIG. 1 is a side view of the enclosure with the receptacle cover assembly in the closed position. The view is with the side of the enclosure shell removed to reveal the components within the enclosure.

FIG. 2 is a side view of the enclosure with the receptacle cover assembly in the open position. The view is with the side of the enclosure shell removed to reveal the components within the enclosure.

FIGS. 3A, 3B and 3C are top view, side view and front view of the receptacle cover assembly. This view is without components which may be attached or removed from the receptacle cover assembly.

FIGS. 4A, 4B and 4C are side view, front view and top view of the upper frame arm support which is part of the receptacle cover assembly.

FIGS. 5A and 5B are top view and side view of the junction box cover.

FIG. 6 is a view of the receptacle mounting plate which may be attached to the upper frame arm support of the receptacle cover assembly.

FIG. 7 is a view of the lower cover which may be attached to the lower frame arms of the receptacle cover assembly.

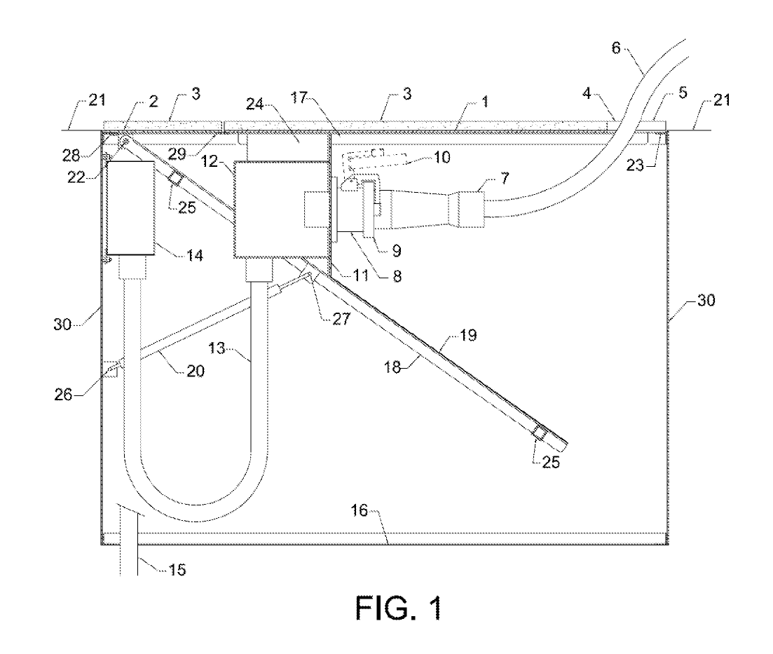

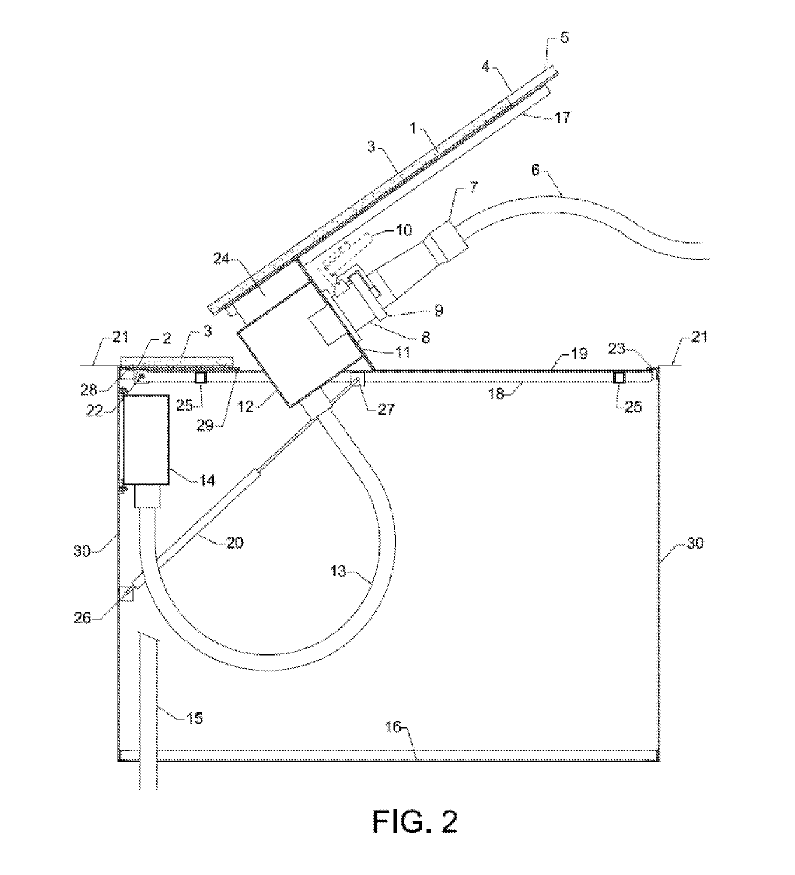

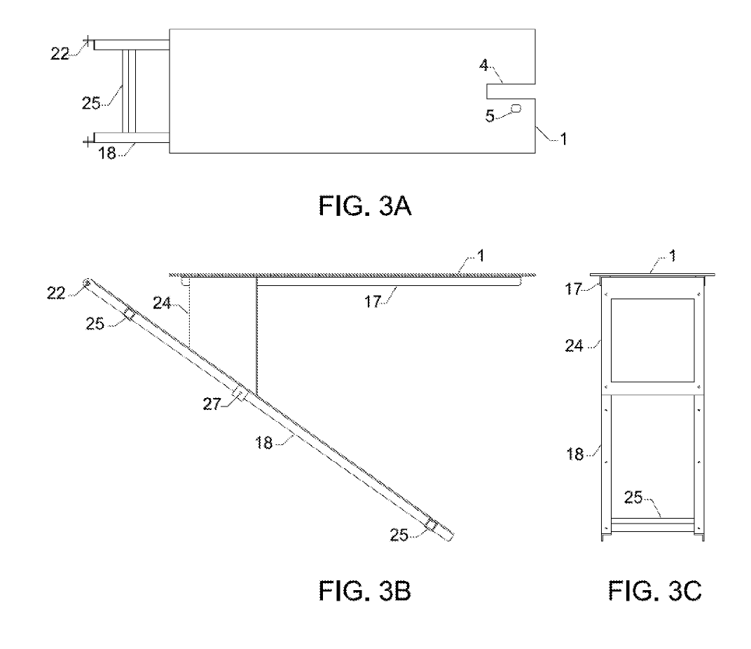

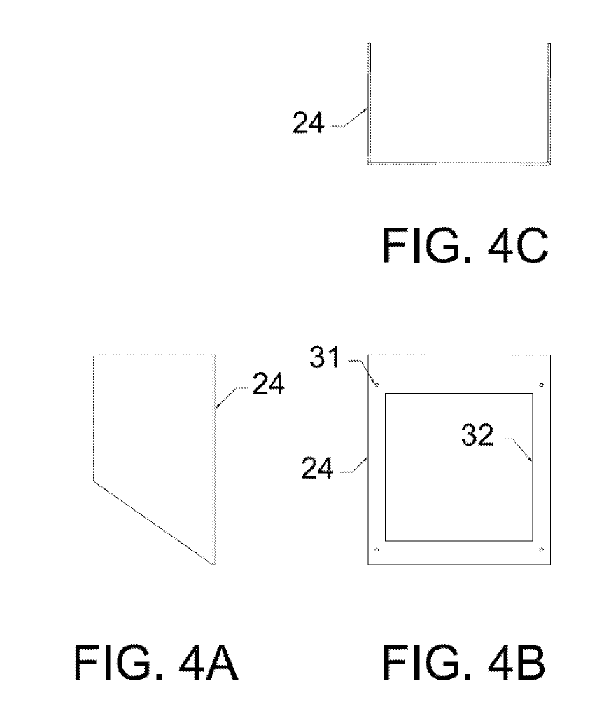

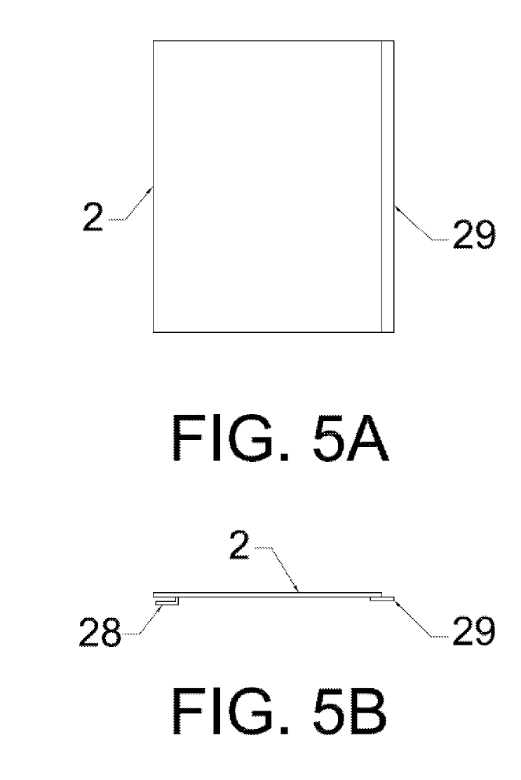

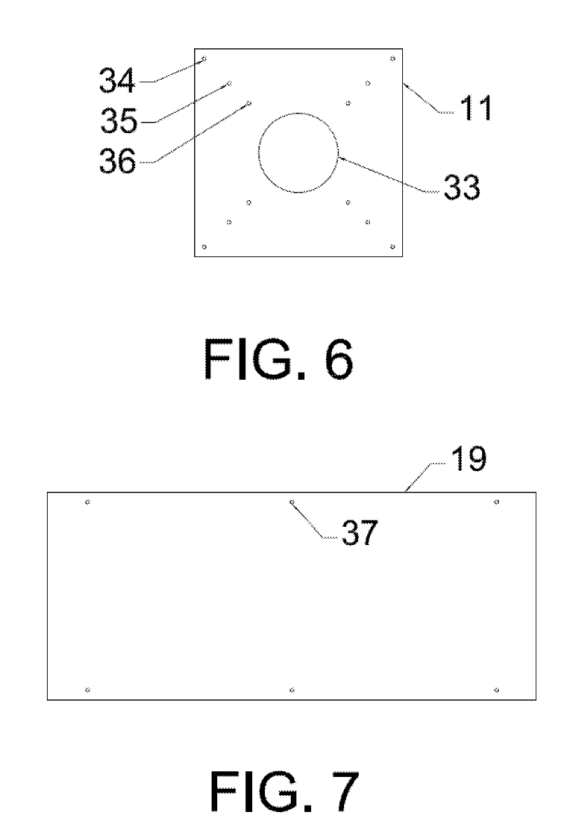

### DETAILED DESCRIPTION OF EXAMPLE EMBODIMENTS

Reference is made herein to some specific examples of the present invention, including any best modes contemplated by the inventor for carrying out the invention. Examples of these specific embodiments are illustrated in the accompanying figures. While the invention is described in conjunction with these specific embodiments, it will be understood that it is not intended to limit the invention to the described or illustrated embodiments. To the contrary, it is intended to cover alternatives, modifications, and equivalents as may be included within the spirit and scope of the invention as defined by the appended claims.

In various example embodiments, a ‘hidden’ electrical in-ground box is provided that comprises an electrical utility box designed to be installed flush with the ground or floor surface 21 enclosing water-tight electrical connections and featuring a recessed covers 1 and 2 with an insert 3 matched to the surrounding surface 21 to allow the box to virtually disappear when not in use. In various example embodiments the box may allow for connection of up to 100 amps, for example with single or three-phase electrical receptacle 8, plug 7 and device cable 6. A receptacle cover 1 is provided with a cable opening 4 which allows the cover to be completely closed while in use.

In various example embodiments, two steel covers 1 and 2 make up the top of the ‘hidden’ electrical in-ground box: the junction box cover 2 and the receptacle cover 1.

In various example embodiments, both the junction box cover 2 and the receptacle cover 1 may be recessed, for instance up to ¾ inch, from the top edge of the enclosure shell 30 wall with optional finish inserts 3 to match the surrounding finished grade or floor 21 the enclosure 30 may be installed in. Finish inserts 3 may be made from formed polymer with imbedded material to match concrete, asphalt or mulch surfaces, for example. Other finish inserts may match wood decked surfaces and synthetic turf inserts match surrounding turf surfaces, for example. A cover support flange 23 surrounds the interior of the enclosure shell 30 near the top of the enclosure for the covers 1 and 2 to rest upon in the closed position and for the lower cover of the receptacle cover assembly 19 to rest upon when the cover assembly is in the open position. The edge of the enclosure shell 30 may be all that may be visible, which may be ¼ inch wide in one example embodiment. When the ‘turf’ insert 30 may be used, even the minimal enclosure shell 30 edge may disappear. The finish inserts 30 may be attached to the rigid covers 1 and 2, which may be made from steel or aluminum or the like. The finish insert 30 which may be attached to the receptacle cover 1 will raise and lower with the cover when the box is in use.

In various example embodiments, the junction box cover 2 may be located near the rear of the enclosure and cover the junction boxes 12 and 14 used to make connections from the incoming electrical service 15 to the fixed junction box 14 and hidden receptacle back box 12 which houses the electrical wiring connections to the receptacle 8. This cover 2 may be removable for electrical connections to be made. This cover 8 may feature hidden tabs 28 and 29 locking the cover into place when the receptacle cover 2 may be closed and allowing easy removal when the receptacle cover 1 may be in the open position. This design allows the junction box cover 2 to have no exposed bolts or fasteners in certain example embodiments.

In various example embodiments, the receptacle cover 1 assembly may have a hinge point 22 which allows the hinged cover 1 that raises and lowers along with the receptacle 8 to allow the plugging-in of an electrical plug 8 and cable 6. This cover assembly may be made up of the recessed cover 1 with finish insert 3, hinged frame arms 17 and 18, lower frame arm cross supports 25, upper frame arm support 24, receptacle 8, receptacle mounting plate 11, lower cover 19 and lift assist pneumatic cylinders 20, in various example embodiments. The upper frame arm support 24 has an opening cut to allow the receptacle 8 to enter the receptacle back box 12 and holes 31 for attachment of the receptacle mounting plate 11 to the upper frame arm support 24.

The finish insert 3 matching the surrounding surface 21 may be attached to the recessed cover 1. The cover 1 and finish insert 3 may be slotted at the opening end 4 of the box to allow the cover to close while a cable 6 may be plugged into the receptacle 8. The cover 1 may have a rotating latch 5 to secure it when not in use and unattended.

In various example embodiments, the receptacle mounting plate 11 may be the surface which the electrical receptacle 8 may be installed in. It may be an interchangeable plate with an opening 33 cut out to accept the mounting configuration of different water tight electrical receptacles 8 from 20 amps up to 100 amps, for example. The receptacle mounting plate 11 may have holes 34 for attaching the mounting plate 11 to holes 31 in the upper frame arm support 24. The receptacle mounting plate 11 may also have holes 35 for attaching the receptacle back box 12 to the receptacle mounting plate 11. The receptacle mounting plate 11 may also have holes 36 for mounting the receptacle 8 to the receptacle mounting plate 11. The receptacle 8 may be installed so that the receptacle waterproof cap may be in the raised position 10 when the plug 7 is plugged in or be in the closed position 9 when the plug 7 is not plugged in.

In various example embodiments, the receptacle 8 may be able to be raised and lowered with the receptacle cover 1 by the use of a flexible cable connection 13 between the fixed junction box 14 and the movable receptacle back box 12.

In various example embodiments, the lower cover 19 may be a cover below the receptacle attached via holes in the lower cover 37 to the lower frame arms 18 of the receptacle cover assembly and which rises with the receptacle cover assembly to close off the bottom of the box from sight when the cover 1 may be in the raised position.

In various example embodiments, the frame of the receptacle cover assembly may be raised and lowered with the help of pneumatic lift assist cylinders 20 on both sides of the box that are sized and selected to reduce any perceived weight of the cover when opening or closing. The lift assist cylinders 20 are attached to the box enclosure at lower mounting points 26 and to the lower frame arms 18 of the receptacle cover assembly at upper mounting points 27.

In various example embodiments, the box enclosure and covers may be constructed of any suitable material, such as mild steel and/or stainless steel with thickness and structural reinforcement for specific ANSI 77 traffic load ratings, for example.

In various example embodiments, the bottom of the box enclosure shell 30 may be open 16 and designed for the boxes to be installed on a bed of gravel for proper drainage. Approximate dimensions of the enclosure as described for use with a 100 amp device may be 13″ wide by 48″ long by 35″ deep for example.

Any of the suitable technologies, materials, and designs set forth and incorporated herein may be used to implement various example aspects of the invention as would be apparent to one of skill in the art.

Although exemplary embodiments and applications of the invention have been described herein including as described above and shown in the included example Figures, there may be no intention that the invention be limited to these exemplary embodiments and applications or to the manner in which the exemplary embodiments and applications operate or are described herein. Indeed, many variations and modifications to the exemplary embodiments are possible as would be apparent to a person of ordinary skill in the art. The invention may include any device, structure, method, or functionality, as long as the resulting device, system or method falls within the scope of one of the claims that are allowed by the patent office based on this or any related patent application.

What is claimed is:

1. An electrical connection box system substantially as shown and described herein.

2. A method of using an electrical connection box system, comprising steps substantially as shown and described herein.
